(19) United States
(12) Patent Application Publication
(10) Pub. No.: US 2009/0027469 A1
(43) Pub. Date: Jan. 29, 2009

(54) INK SUPPLYING SYSTEM

(75) Inventor: Juichi FURUKAWA, Kanagawa (JP)

Correspondence Address: COOPER & DUNHAM, LLP, 30 Rockefeller Plaza, 20th Floor, NEW YORK, NY, 10112, US

(73) Assignee: RICOH COMPANY, LTD., Tokyo (JP)

(21) Appl. No.: 12/174,250

(22) Filed: Jul. 16, 2008

(30) Foreign Application Priority Data
Jul. 26, 2007 (JP) 2007-194207

(51) Int. Cl. B41J 2/175

(52) U.S. Cl. 347/93

(57) ABSTRACT

An ink supplying system is disclosed. The ink supplying system includes an ink tank, an adapter, an ink supplying tube, and a filter unit. The ink tank stores ink. The adapter includes a connecting section, and the adapter is detachably attached to an ink cartridge attaching section of a main body of an image forming apparatus via the connecting section, to which ink cartridge attaching section an ink cartridge is originally detachably attached. The ink supplying tube connects the ink tank to the connecting section of the adapter. The filter unit is in the middle of the ink supplying tube and the filter unit is changeable.

### BACKGROUND OF THE INVENTION

1. Field of the Invention

The present invention generally relates to an ink supplying system for supplying ink to a main body of an image forming apparatus via an adapter which is attached to an ink cartridge attaching section of the main body of the image forming apparatus.

2. Description of the Related Art

As an image forming apparatus such as a printer, a facsimile machine, a copier, and a multifunctional apparatus that has the above functions, for example, there is an apparatus using a liquid ejecting device having a liquid ejecting head which ejects recording liquid (ink) onto a recording medium for forming an image on the recording medium. The recording medium is not limited to a sheet, and other recording media such as an image transferring medium and recording paper can be used as the recording medium; and the image forming includes image recording, image printing, letter printing, letter transferring and so on.

In the present invention, the image forming apparatus forms an image on a recording medium formed of materials such as paper, thread, string, cloth, leather, metal, glass, wood, plastic, and ceramics by ejecting recording liquid onto the recording medium. Further, the image forming includes attaching an image such as a pattern onto a recording medium in addition to attaching an image having a meaning such as a letter and a figure onto the recording medium. The ink is not limited to ink itself and can be fluid (recording liquid) to be ejected for forming an image on a recording medium.

In the image forming apparatus (hereinafter, in some cases, referred to as an inkjet recording apparatus), in order to supply ink to a recording head, an ink cartridge is generally used. The ink cartridge is installed in a carriage together with a recording head, or the ink cartridge is detachably attached to an ink cartridge attaching section of a main body of the image forming apparatus and ink in the ink cartridge is supplied to a sub tank connected to the recording head side via an ink supplying tube.

When the ink cartridge is attached to the ink cartridge attaching section of the main body of the image forming apparatus, since the ink cartridge is contained in the main body, the size of an ink container in the ink cartridge may be relatively small. When a user continuously uses the image forming apparatus and a large amount of the ink is consumed, the user must frequently replace an old ink cartridge with a new ink cartridge.

In order to solve the above problem, Patent Document 1 discloses an ink continuously supplying device. In the device, an ink storing section whose capacity is great is provided outside an image forming apparatus, and a tube is connected between the ink storing section and an adapter fixed to an ink container in a main body of the image forming apparatus.

In addition, when foreign substances such as dust are mixed into ink to be supplied to a recording head, nozzles of the recording head are clogged by the foreign substances and defective ejection of ink occurs. In order not to mix the foreign substances into the ink, a filter unit is installed in an ink supplying route from an ink container to the recording head. Generally, the filter unit is fixed to a main body of an apparatus. However, in Patent Documents 2 and 3, the filter unit can be changed.

[Patent Document 1] Japanese Laid-Open Patent Application No. 7-117235

[Patent Document 2] Japanese Patent No. 3230424

[Patent Document 3] Japanese Patent No. 3201053

As other related Patent Documents, Patent Documents 4 through 6 exist.

[Patent Document 4] Japanese Laid-Open Patent Application No. 4-212864

[Patent Document 5] Japanese Laid-Open Patent Application No. 1-133747

[Patent Document 6] Japanese Laid-Open Patent Application No. 2004-203019

However, in Patent Document 1, the ink continuously supplying device does not provide a filter; the filter is in the main body of the apparatus to which the ink is supplied, and the filter filters out the foreign substances such as the dust and the large particles in the ink. However, the amount of the foreign substances which can be removed by the filter is limited to a certain amount, and when the ink continuously supplying device is used and the filter in the main body is clogged, the ink continuously supplying device cannot be operated well.

In Patent Documents 2 and 3, the filter unit in the apparatus main body is changeable. However, the filter unit is installed at a position at the back of a slit where an ink cartridge is inserted. Consequently, changing the filter unit may not be easy.

### SUMMARY OF THE INVENTION

In a preferred embodiment of the present invention, there is provided an ink supplying system having an ink storing section which can be used for a long period.

Features and advantages of the present invention are set forth in the description that follows, and in part will become apparent from the description and the accompanying drawings, or may be learned by practice of the invention according to the teachings provided in the description. Features and advantages of embodiments of the present invention will be realized and attained by an ink supplying system having an ink storing section particularly pointed out in the specification in such full, clear, concise, and exact terms so as to enable a person having ordinary skill in the art to practice the invention.

To achieve one or more of these and other advantages, according to one aspect of the present invention, there is provided an ink supplying system. The ink supplying system includes an ink storing section which stores ink; an adapter, which is detachably attached to an ink cartridge attaching section of a main body of an image forming apparatus to which ink cartridge attaching section an ink cartridge is originally detachably attached, and includes a connecting section with which the adapter is connected to the main body of the image forming apparatus; an ink supplying tube which forms an ink supplying route for connecting the ink storing section to the connecting section of the adapter; and a filter unit which filters out foreign substances in the ink at a position in the ink supplying route which route connects the ink storing section to the connecting section of the adapter. The filter unit is changeable.

According to another aspect of the present invention, the ink supplying system further includes a first air open valve secured to the ink storing section, and an air pump connected between the first air open valve and the ink storing section.

### EFFECT OF THE INVENTION

According to an embodiment of the present invention, an ink supplying system includes an ink storing section, an adapter, an ink supplying tube, and a filter unit. The ink storing section stores ink. The adapter includes a connecting section, and the adapter is detachably attached to an ink cartridge attaching section of a main body of an image forming apparatus via the connecting section, to which ink cartridge attaching section an ink cartridge is originally detachably attached. The ink supplying tube connects the ink storing section to the connecting section of the adapter. The filter unit is in the middle of the ink supplying tube. Since the filter unit is changeable, the image forming apparatus having the ink supplying system can be operated for a long period by changing the filter unit.

In addition, the ink supplying system further includes a first air open valve secured to the ink storing section, and an air pump connected between the first air open valve and the ink storing section. Therefore, even if air bubbles are mixed into the ink supplying tube when the filter unit is changed, the mixed air bubbles can be discharged by operations of the first air valve and the air pump.

### BRIEF DESCRIPTION OF THE DRAWINGS

Features and advantages of the present invention will become more apparent from the following detailed description when read in conjunction with the accompanying drawings, in which:

FIG. 1 is a schematic diagram showing a structure of an image forming apparatus to which ink is supplied by an ink supplying system of the present invention;

FIG. 2 is a plan view of a main part of the image forming apparatus shown in FIG. 1;

FIG. 3 is a perspective view of an ink cartridge shown in FIG. 2;

FIG. 4 is a cut-away side view of the ink cartridge shown in FIG. 3;

FIG. 5 is a schematic diagram showing an ink supplying system according to a first embodiment of the present invention;

FIG. 6 is an enlarged view of a filter unit shown in FIG. 5;

FIG. 7 is a schematic diagram showing an ink supplying system using a syringe according to the first embodiment of the present invention;

FIG. 8 is a schematic diagram showing an ink supplying system according to a second embodiment of the present invention;

FIG. 9 is an enlarged view of a filter unit shown in FIG. 8;

FIG. 10 is a schematic diagram showing an ink supplying system according to a third embodiment of the present invention;

FIG. 11 is a schematic diagram showing an ink supplying system according to a fourth embodiment of the present invention;

FIG. 12 is a schematic diagram showing an ink supplying system according to a fifth embodiment of the present invention;

FIG. 13 is a schematic diagram showing an ink supplying system according to a sixth embodiment of the present invention;

FIG. 14 is a schematic diagram showing an ink supplying system according to a seventh embodiment of the present invention;

FIG. 15 is a schematic diagram showing an ink supplying system according to an eighth embodiment of the present invention;

FIG. 16 is a schematic diagram showing an ink supplying system according to a ninth embodiment of the present invention;

FIG. 17 is an enlarged view of a filter unit shown in FIG. 16;

FIG. 18 is a schematic diagram showing an ink supplying system according to a tenth embodiment of the present invention;

FIG. 19 is an enlarged view of a filter unit shown in FIG. 18; and

FIG. 20 is a schematic diagram showing an ink supplying system according to a comparison example.

### DESCRIPTION OF THE PREFERRED EMBODIMENTS

### BEST MODE FOR CARRYING OUT THE INVENTION

The best mode of carrying out the present invention is described with reference to the accompanying drawings.

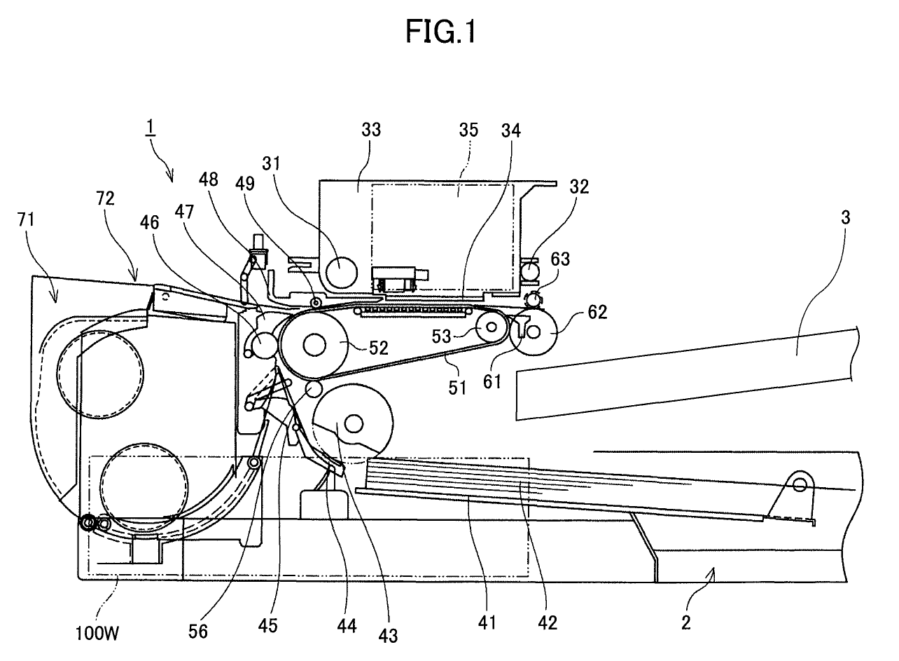

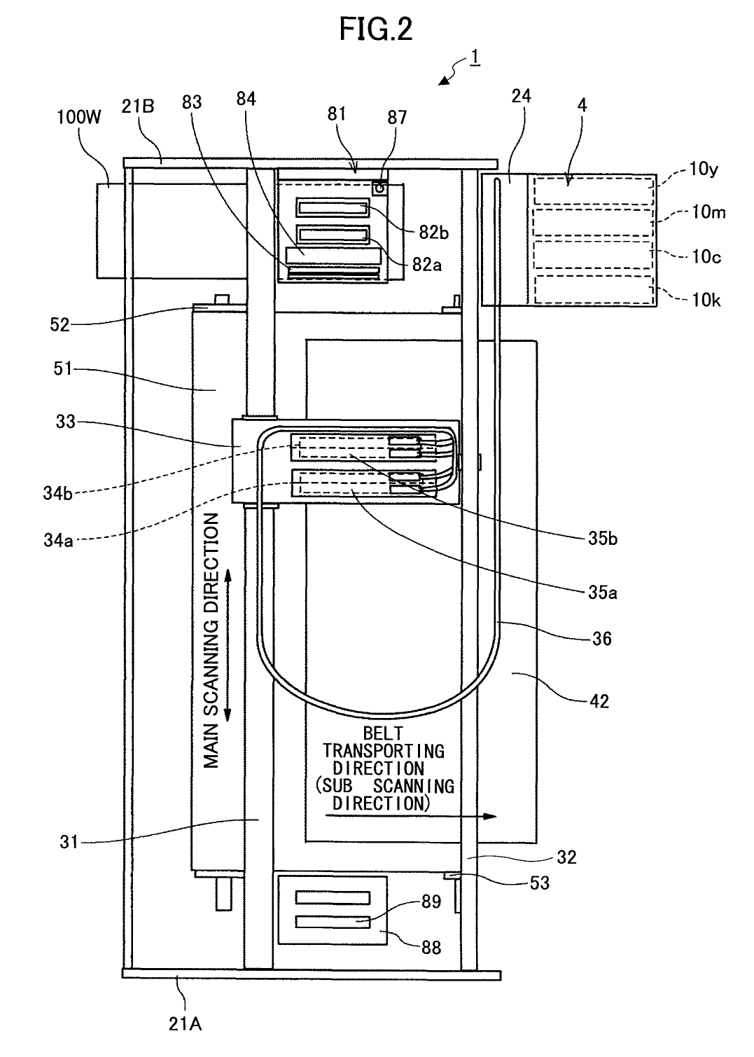

First, referring to FIGS. 1 and 2, an image forming apparatus is described to which ink is supplied by an ink supplying system of the present invention. FIG. 1 is a schematic diagram showing a structure of an image forming apparatus to which ink is supplied by an ink supplying system of the present invention. FIG. 2 is a plan view of a main part of the image forming apparatus shown in FIG. 1.

The image forming apparatus shown in FIG. 1 is a serial type inkjet recording apparatus. In the image forming apparatus, a carriage 33 is slidably held in the main scanning direction by a driving guide rod 31 and a driven guide rod 32 held between side plates 21A and 21B of an apparatus main body 1, and the carriage 33 is moved in the main scanning direction (the arrow direction shown in FIG. 2) by a main scanning direction motor (not shown) via a timing belt (not shown).

Recording heads 34a and 34b for ejecting ink droplets (liquid droplets) of yellow (Y), cyan (C), magenta (M), and black (K) are installed in the carriage 33. When color is not referred to, the recording head 34 is used to represent the recording heads 34a and 34b. The recording head 34 includes a nozzle array formed of plural nozzles in the sub scanning direction orthogonal to the main scanning direction, and the ink droplet ejecting direction from the nozzle array faces the downward direction.

The recording head 34a provides two nozzle arrays, and one of the two nozzle arrays ejects black (K) ink droplets and the other of the two nozzle arrays ejects cyan (C) ink droplets. The recording head 34b provides two nozzle arrays, and one of the two nozzle arrays ejects magenta (M) ink droplets and the other of the two nozzle arrays ejects yellow (Y) ink droplets.

The carriage 33 further provides sub tanks 35a and 35b (second ink supplying sections) from which ink is supplied to the nozzle arrays of the recording head 34. When color is not referred to, the sub tank 35 is used to represent the sub tanks 35a and 35b. Ink cartridges 10y, 10m, 10c, and 10k (first ink supplying sections) where corresponding color recording liquids (ink) are stored are detachably attached to an ink cartridge attaching section 4. The color recording liquid is supplied to the sub tank 35 from the corresponding ink cartridges 10y, 10m, 10c, and 10k via an ink supplying pipe 36 by operations of an ink supplying pump unit 24. When color is not referred to, an ink cartridge 10 represents the ink cartridges 10y, 10m, 10c, and 10k.

In order to feed a sheet (paper) 42 stacked on a sheet storing section 41 (thick board) of a sheet feeding tray 2 to an image forming region, the image forming apparatus includes a half-moon roller 43 (sheet feeding roller) for feeding each sheet 42 one by one from the sheet storing section 41 and a separation pad 44 formed of a material having a high friction coefficient. The separation pad 44 is pushed toward the sheet feeding roller 43.

In addition, in order to transport the sheet 42 to a position under the recording head 34, the image forming apparatus includes a guide member 45 for guiding the sheet 42, a counter roller 46, a sheet transporting guide member 47, a pushing member 48 having a sheet tip pushing roller 49, and a transport belt 51 (transport unit) for transporting the sheet 42 to a position facing the recording head 34 by adhering the sheet 42 with an electrostatic force.

The transport belt 51 is an endless belt which is wound around a transporting roller 52 and a tension roller 53, and moves in the belt transporting direction (the sub scanning direction) at the position facing the recording head 34. The image forming apparatus further includes a charging roller 56 (charging unit) for charging the surface of the transport belt 51. The charging roller 56 is rotated by the rotation of the transport belt 51 by contacting the surface of the transport belt 51. The transport belt 51 is rotated in the belt transporting direction by a sub scanning direction motor (not shown) via a timing belt (not shown).

In order to output the sheet 42 on which an image is formed by the recording head 34, the image forming apparatus further includes a separation claw 61 for separating the sheet 42 from the transport belt 51, a sheet outputting roller 62, a spur 63, and a sheet outputting tray 3 under the sheet outputting roller 62.

In addition, a duplex print unit 71 is detachably attached to the apparatus main body 1 on the back surface of the apparatus main body 1. The duplex print unit 71 receives the sheet 42 returned from the transport belt 51 by the reverse rotation of the transport belt 51, inverts the sheet 42, and transports the inverted sheet 42 between the counter roller 46 and the transport belt 51 again. The upper surface of the duplex print unit 71 is a manual sheet feeding tray 72.

In addition, as shown in FIG. 2, a head maintaining and recovering mechanism 81 is at a non-printing region located at one side in the main scanning direction of the carriage 33 in the apparatus main body 1. The head maintaining and recovering mechanism 81 maintains normal conditions of the nozzles of the recording head 34 and recovers from abnormal conditions of the nozzles of the recording head 34.

The head maintaining and recovering mechanism 81 includes cap members 82a and 82b for capping the nozzle surfaces of the recording head 34, a wiper member 83 (wiper blade) for wiping the nozzle surfaces of the recording head 34, an idle ink droplet receiving section 84 for receiving ink droplets (liquid droplets) whose viscosity becomes high by not contributing to forming an image, a wiper cleaning section (not shown) formed with the idle ink droplet receiving section 84 for removing ink adhered onto the wiper member 83, a wiper cleaner (not shown) for pushing the wiper member 83 toward the wiper cleaning section when the wiper member 83 is cleaned, and a carriage lock 87 for locking the carriage 33. In some cases, a cap member 82 represents the cap members 82a and 82b. In addition, a waste ink tank 100W is detachably attached to the apparatus main body 1 under the head maintaining and recovering mechanism 81 for storing waste ink discharged by the operations of the head maintaining and recovering mechanism 81.

Further, as shown in FIG. 2, in a non-printing region located at the other side in the main scanning direction of the carriage 33 in the apparatus main body 1, an idle ink droplet receiving section 88 is located for receiving ink droplets whose viscosity becomes high by not contributing to forming an image. The idle ink droplet receiving section 88 includes openings 89 along the nozzle arrays of the recording head 34.

In the image forming apparatus, the sheets 42 are fed from the sheet feeding tray 2 one by one in an approximately vertical direction, the sheet 42 is guided by the guide member 45, and is transported between the transport belt 51 and the counter roller 46. The tip of the sheet 42 is guided by the sheet transporting guide member 47 and is pushed onto the transport belt 51 by the sheet tip pushing roller 49. Then the transport direction of the sheet 42 is changed approximately 90 degrees relative to the original direction.

At this time, an AC voltage is applied onto the charging roller 56 and the surface of the transport belt 51 attains alternating charged patterns in which positive electric charges and negative electric charges are alternately collected on the surface of the transport belt 51 with a predetermined width pattern in the sub scanning direction. When the sheet 42 is transported onto the transport belt 51 whose surface is alternately charged by the positive electric charges and the negative electric charges, the sheet 42 is adhered onto the surface of the transport belt 51 and is transported in the sub scanning direction by the rotation of the transport belt 51.

When the recording head 34 is driven corresponding to an image signal while the carriage 33 is being moved, the recording head 34 ejects ink droplets on the stopped sheet 42 and one line of an image is recorded (printed) on the sheet 42. Then the sheet 42 is transported by a predetermined length in the sub scanning direction and the next line of the image is recorded on the sheet 42. When the image forming apparatus receives a printing completion signal or a signal that the back end of the sheet 42 has reached the end of the printing region of the apparatus main body 1, the image forming apparatus ends the printing operations and outputs the sheet 42 to the sheet outputting tray 3.

When the maintaining and recovering operations of the nozzles of the recording head 34 are executed, the carriage 33 is moved to a home position of the carriage 33 facing the head maintaining and recovering mechanism 81. At that position, ink droplet suctioning operations are executed while capping the nozzle surfaces of the recording head 34 with the cap member 82, and the remaining ink droplets which do not contribute to forming an image are ejected by idle ejection. With this, an image can be formed by a stable ink droplet ejection.

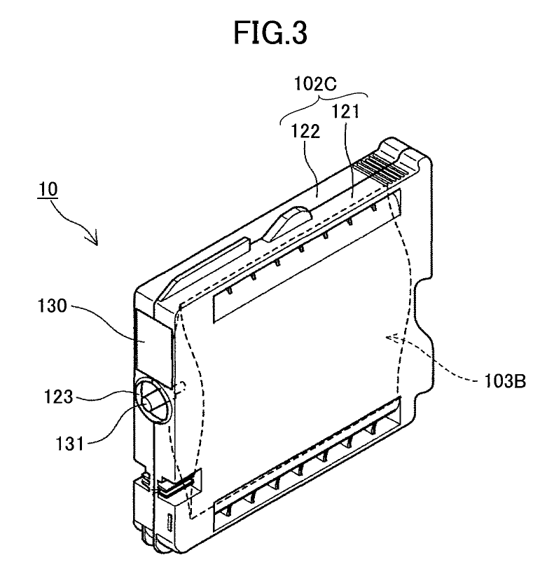

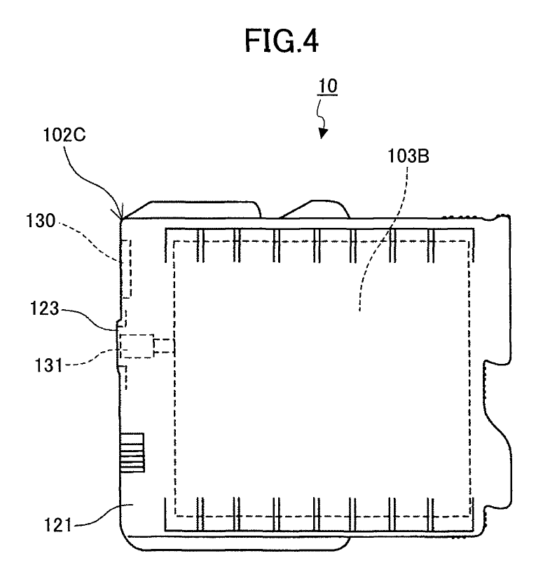

Next, referring to FIGS. 1 through 4, the ink cartridge 10 is described in detail. FIG. 3 is a perspective view of the ink cartridge 10 shown in FIG. 2. FIG. 4 is a cut-away side view of the ink cartridge 10 shown in FIG. 3.

As shown in FIGS. 3 and 4, the ink cartridge 10 includes a cartridge case 102C and an ink bag 103B (recording liquid containing unit). The ink bag 103B is contained in the cartridge case 102C. The cartridge case 102C is divided into a first case 121 and a second case 122 which can be assembled again.

The cartridge case 102C provides an opening 123 corresponding to an ink supplying opening 131 of the ink bag 103B.

When the ink cartridge 10 is attached to the ink cartridge attaching section 4 (see FIG. 2), a hollow needle (not shown) formed at the end of the ink cartridge attaching section 4 is inserted into the ink supplying opening 131 of the ink bag 103B, and the ink bag 103B is connected to the ink supplying pump unit 24 (see FIG. 2). With this, the ink in the ink bag 103B can be supplied to the sub tank 35 via the ink supplying pipe 36 (see FIG. 2).

A non-volatile memory unit 130 formed of, for example, an EEPROM, is at the upper front surface of the ink cartridge 10. The non-volatile memory unit 130 stores information of the ink cartridge 10, an updated control program of the image forming apparatus, and so on. The information of the ink cartridge 10 includes, for example, information of an ink color, an ink type, an expiration date for use, an ID number, an authorized product, the number of ink filling times, the remaining amount of ink, and a version.

When the ink cartridge 10 is attached to the ink cartridge attaching section 4, the ink cartridge 10 is electrically connected to electrodes of the apparatus main body 1, the information in the non-volatile memory unit 130 can be read by the apparatus main body 1, and the apparatus main body 1 can write information in the non-volatile memory unit 130.

Next, referring to the drawings, ink supplying systems according to embodiments of the present invention are described in detail.

### First Embodiment

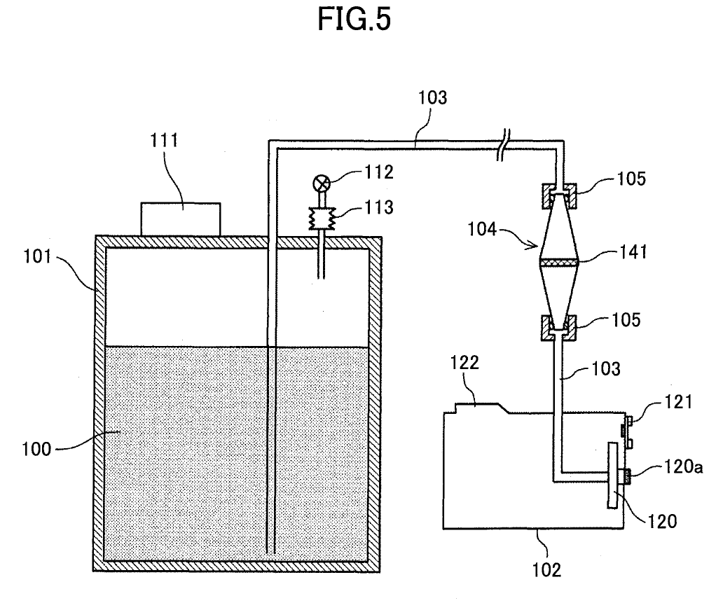

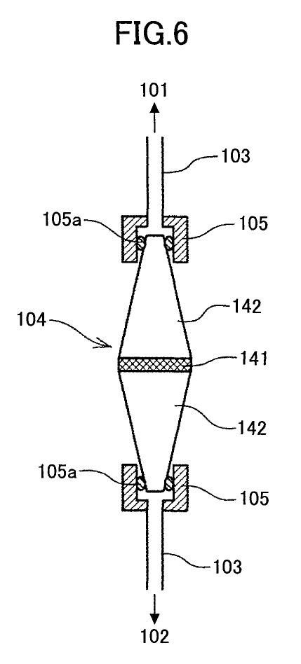

First, referring to FIGS. 5 and 6, an ink supplying system according to a first embodiment of the present invention is described. FIG. 5 is a schematic diagram showing the ink supplying system according to the first embodiment of the present invention. FIG. 6 is an enlarged view of a filter unit shown in FIG. 5.

As shown in FIG. 5, the ink supplying system in the first embodiment of the present invention includes an ink tank 101 (ink storing section), an adapter 102, an ink supplying tube 103 (ink supplying route), and a filter unit 104. The ink tank 101 stores ink 100. The adapter 102 includes a connecting section 120, and the adapter 102 is detachably attached to the ink cartridge attaching section 4 to which the ink cartridge 10 is originally detachably attached. The ink supplying tube 103 connects the ink tank 101 to the connecting section 120 of the adapter 102. The filter unit 104 is in the middle of the ink supplying tube 103 connecting the ink tank 101 to the adapter 102.

The ink tank 101 includes an opening (not shown) from which the ink 100 is supplied into the ink tank 100, a lid 111 for covering the opening, an air open valve 112 (first air open valve) by which air is input/output into/from the ink tank 100, and an air pump 113 which forcibly outputs air inside the ink tank 101 or inputs air into the ink tank 101 via the air open valve 112.

The connecting section 120 includes an elastic member 120a into which the hollow needle of the ink cartridge attaching section 4 is inserted. In addition, the adapter 102 includes an IC (integrated circuit) 121 and a recognition rib 122. The inside of the adapter 102 is hollow. The adapter 102 has functions by which the apparatus main body 1 accepts the ink supplying system. Specifically, the apparatus main body 1 recognizes an ink color by the recognition rib 122 (protrusion), and the IC 121 is an information recording medium capable of having information read and written. The IC 121 stores information of the ink supplying system, for example, an ink type, an expiration date for use of the ink 100, and so on.

As shown in FIG. 6, the filter unit 104 includes a filter 141 and horn-shaped members 142, and the filter 141 and the horn-shaped members 142 are formed as one unit or can be formed separately. One of the horn-shaped members 142 is connected to a joint 105 connected to the ink supplying tube 103 to the ink tank 101 via an O-ring 105a, and the other of the horn-shaped members 142 is connected to a joint 105 connected to the ink supplying tube 103 to the adapter 102 via an O-ring 105a.

The ink tank 101 can include a sensor for detecting a remaining amount of ink in the ink tank 101, or a part or the entire part of the ink tank 101 can be formed of a material which transmits light so that the remaining amount of ink in the ink tank can be observed. Generally, the ink tank 101 is formed of a solid material for storing the ink 100. In addition, the ink supplying tube 103 is directly connected to the connecting section 120 of the adapter 102. However, an ink storing unit (not shown) can be formed in the adapter 102; in this case, the ink supplying tube 103 is connected to the ink storing unit and the ink storing unit is connected to the connecting section 120.

In the ink supplying system of the present embodiment, instead of attaching the ink cartridge 10 to the ink cartridge attaching section 4 of the apparatus main body 1 (see FIG. 2), the adapter 102 is attached to the ink cartridge attaching section 4 of the apparatus main body 1. With this, the ink 100 is supplied to the apparatus main body 1 via the ink tank 101, the ink supplying tube 103, the filter unit 104, the ink supplying tube 103, the connecting section 120 of the adapter 102, and the hollow needle of the ink cartridge attaching section 4.

At this time, foreign substances in the ink 100 are filtered out by the filter 141 of the filter unit 104. When the filter unit 104 is desired to be changed, the horn-shaped members 142 connected to the corresponding joints 105 by the O-rings 105a are extracted from the joints 105. With this, an old filter unit 104 can be easily extracted from the joints 105 and a new filter unit 104 can be easily inserted into the joints 105.

In addition, when the ink 100 is initially supplied to the ink supplying route (from the ink tank 101 to the adapter 102), or after the filter unit 104 is changed, air bubbles in the ink supplying route including the ink supplying tube 103 must be discharged. In this case, the air open valve 112 is opened, air is input to the ink tank 101 by using the air pump 113, and the air bubbles are discharged from the connecting section 120 together with the ink 100. In this case, for example, the air bubbles and the ink 100 are discharged to the waste ink tank 100W (see FIG. 2) by the idle ejection of the recording head 34 (see FIG. 2).

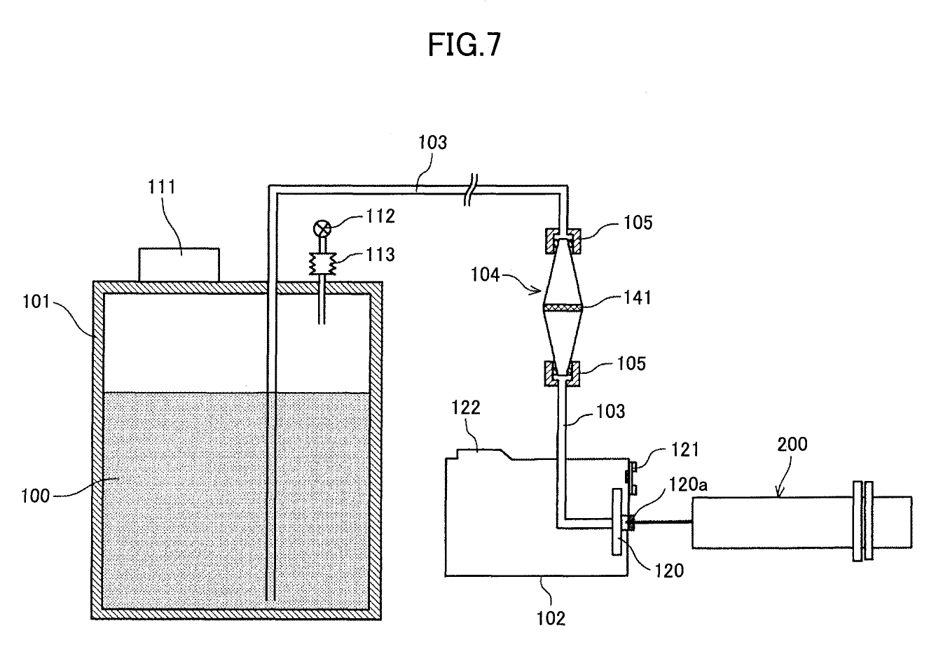

In addition, as shown in FIG. 7, the air bubbles and the ink 100 can be discharged from the connecting section 120 by using a syringe 200. In this case, the needle of the syringe 200 is inserted into the elastic member 120a of the connecting section 120. FIG. 7 is a schematic diagram showing an ink supplying system using a syringe according to the first embodiment of the present invention.

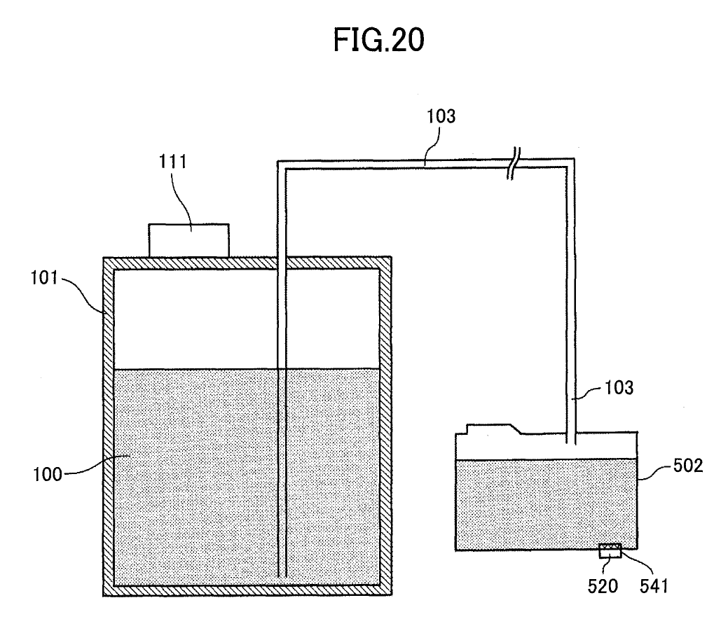

FIG. 20 is a schematic diagram showing an ink supplying system according to a comparison example. As shown in FIG. 20, in the comparison example, a filter 541 is fixed to a connecting section 520 (ink supplying opening to the apparatus main body 1) of an adapter 502. In this case, when the filter 541 is changed, the adapter 502 must be changed together with the filter 541. Consequently, the cost is increased.

As described above, the ink supplying system according to the first embodiment of the present invention includes the ink tank 101, the adapter 102, the ink supplying tube 103, and the filter unit 104. The ink tank 101 stores ink 100. The adapter 102 is detachably attached to the ink cartridge attaching section 4 to which the ink cartridge 10 is originally detachably attached. The ink supplying tube 103 connects the ink tank 101 to the connecting section 120 of the adapter 102. In the middle of the ink supplying tube 103 which connects the ink tank 101 to the connecting section 120 of the adapter 102, the filter unit 104 is disposed. Since the filter unit 104 in the ink supplying system can be changed, the ink supplying system can be used for a long period by changing the filter unit 104 while the ink 100 is added to the ink tank 101. That is, the image forming apparatus can be used for a long period by using the ink supplying system.

### Second Embodiment

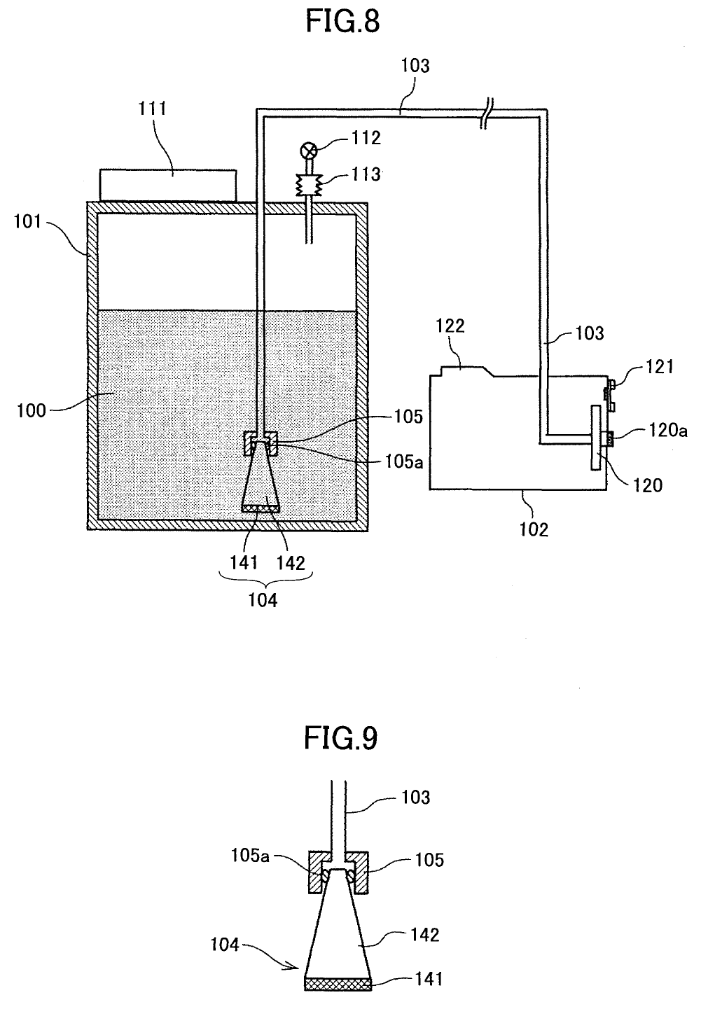

Next, referring to FIGS. 8 and 9, an ink supplying system according to a second embodiment of the present invention is described. FIG. 8 is a schematic diagram showing the ink supplying system according to the second embodiment of the present invention. FIG. 9 is an enlarged view of a filter unit shown in FIG. 8.

In the second embodiment of the present invention, when an element is similar to or the same as that in the first embodiment of the present invention, the same reference number as that in the first embodiment of the present invention is used for the element, and the same description as that in the first embodiment of the present invention is omitted.

As shown in FIG. 8, in the ink supplying system according to the second embodiment of the present invention, the (changeable) filter unit 104 is at the end of the ink supplying tube 103 in the ink tank 101. In addition, as shown in FIGS. 8 and 9, the number of the horn-shaped members 142 is one, the number of the joints 105 is one, and the number of the O-rings 105a is one. Since the number of components is less than that in the first embodiment of the present invention, the cost can be reduced.

In addition, the size of the opening of the ink tank 101 which opening is covered with the lid 111 is greater than the size in the first embodiment of the present invention so that the filter unit 104 can be easily extracted. That is, the filter unit 104 can be easily changed. In addition, the air bubbles entering when the filter unit 104 is changed can be discharged by the same method as that in the first embodiment of the present invention.

### Third Embodiment

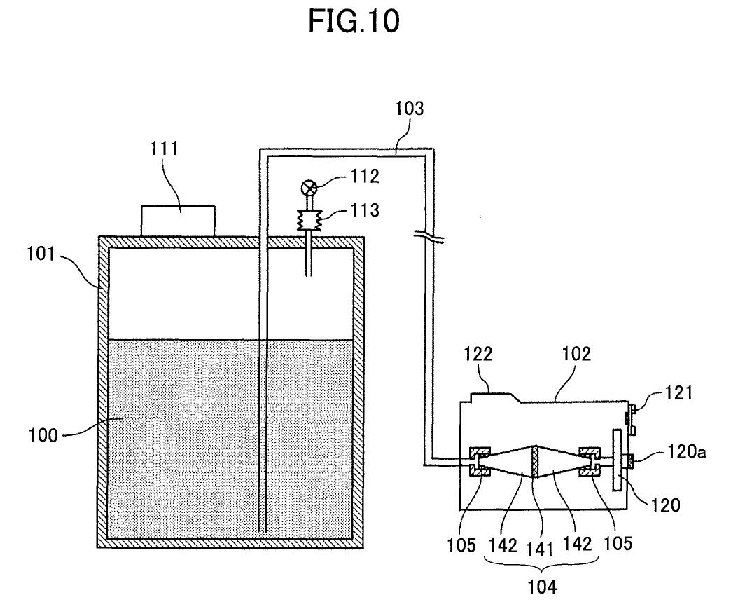

Next, referring to FIG. 10, an ink supplying system according to a third embodiment of the present invention is described. FIG. 10 is a schematic diagram showing the ink supplying system according to the third embodiment of the present invention.

In the third embodiment of the present invention, when an element is similar to or the same as that in the first embodiment of the present invention, the same reference number as that in the first embodiment of the present invention is used for the element, and the same description as that in the first embodiment of the present invention is omitted.

As shown in FIG. 10, in the ink supplying system according to the third embodiment of the present invention, the (changeable) filter unit 104 is in the adapter 102. When the filter unit 104 and the connecting section 120 are in the adapter 102, the structure of the ink supplying system can be simplified.

In addition, when the filter unit 104 is right in front of the connecting section 120 which is to be connected to the apparatus main body 1, foreign substances generated from the ink supplying tube 103 can be filtered out. In addition, the air bubbles entering when the filter unit 104 is changed can be discharged by the same method as that in the first embodiment of the present invention.

### Fourth Embodiment

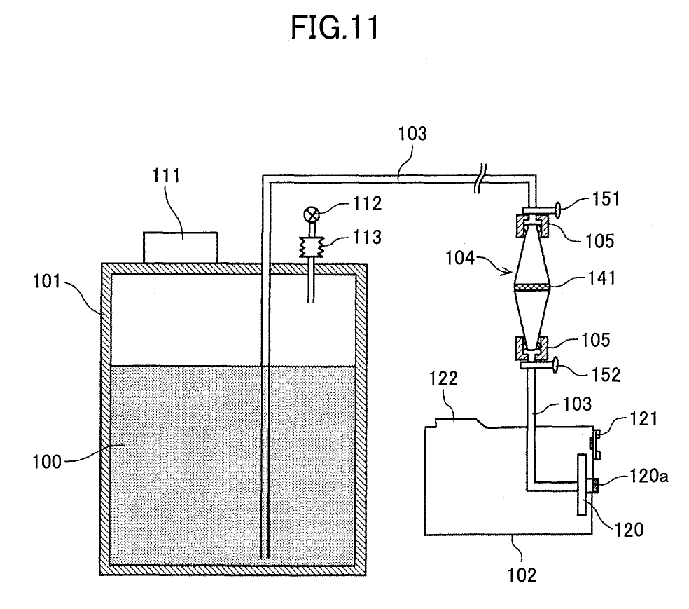

Next, referring to FIG. 11, an ink supplying system according to a fourth embodiment of the present invention is described. FIG. 11 is a schematic diagram showing the ink supplying system according to the fourth embodiment of the present invention.

In the fourth embodiment of the present invention, when an element is similar to or the same as that in the first embodiment of the present invention, the same reference number as that in the first embodiment of the present invention is used for the element, and the same description as that in the first embodiment of the present invention is omitted.

As shown in FIG. 11, in the ink supplying system according to the fourth embodiment of the present invention, a valve 151 capable of opening and closing the ink supplying tube 103 is at the upstream side of the filter unit 104 and a valve 152 capable of opening and closing the ink supplying tube 103 is at the downstream side of the filter unit 104. When the filter unit 104 is changed, the valves 151 and 152 are closed, and leaking of the ink 100 from the ink supplying tube 103 can be prevented and air bubbles flowing into the ink supplying tube 103 can be prevented.

### Fifth Embodiment

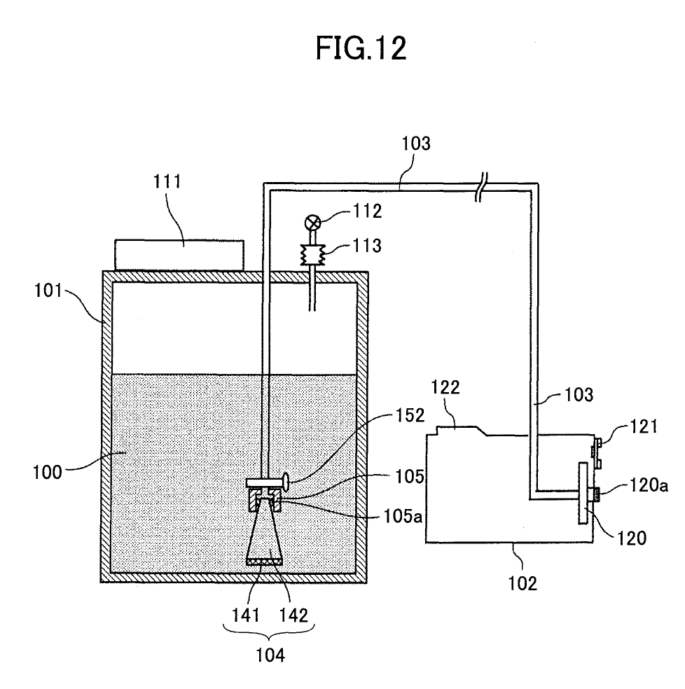

Next, referring to FIG. 12, an ink supplying system according to a fifth embodiment of the present invention is described. FIG. 12 is a schematic diagram showing the ink supplying system according to the fifth embodiment of the present invention.

In the fifth embodiment of the present invention, when an element is similar to or the same as that in the second embodiment of the present invention, the same reference number as that in the second embodiment of the present invention is used for the element, and the same description as that in the second embodiment of the present invention is omitted.

As shown in FIG. 12, when the ink supplying system according to the fifth embodiment of the present invention is compared with the ink supplying system according to the second embodiment of the present invention shown in FIG. 8, a valve 152 capable of opening and closing the ink supplying tube 103 is at the downstream side of the filter unit 104. When the filter unit 104 is changed, the valve 152 is closed, and leaking of the ink 100 from the ink supplying tube 103 can be prevented and air bubbles flowing into the ink supplying tube 103 can be prevented. In addition, when the ink supplying system according to the fifth embodiment of the present invention is compared with the ink supplying system according to the fourth embodiment of the present invention shown in FIG. 11, in the ink supplying system according to the fifth embodiment of the present invention, the number of the valves is one and the cost can be reduced.

### Sixth Embodiment

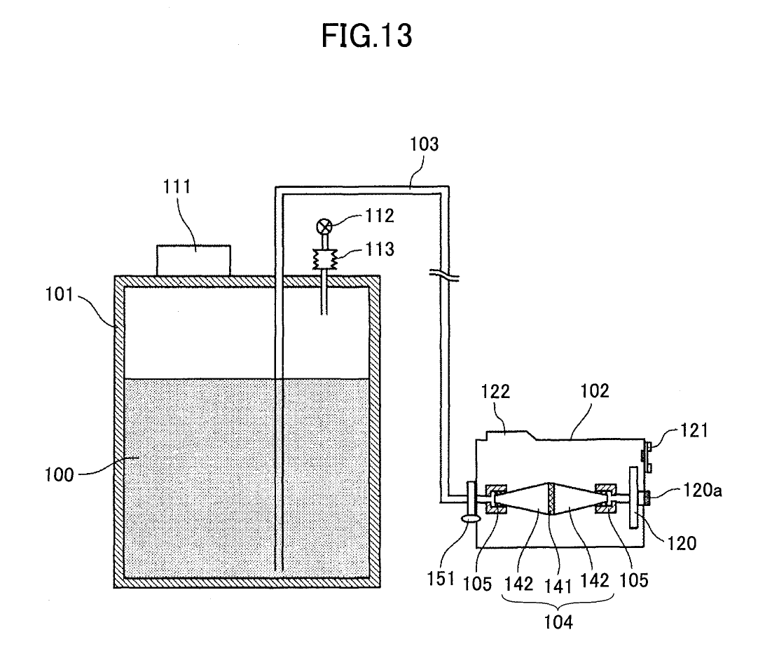

Next, referring to FIG. 13, an ink supplying system according to a sixth embodiment of the present invention is described. FIG. 13 is a schematic diagram showing the ink supplying system according to the sixth embodiment of the present invention.

In the sixth embodiment of the present invention, when an element is similar to or the same as that in the third embodiment of the present invention, the same reference number as that in the third embodiment of the present invention is used for the element, and the same description as that in the third embodiment of the present invention is omitted.

As shown in FIG. 13, when the ink supplying system according to the sixth embodiment of the present invention is compared with the ink supplying system according to the third embodiment of the present invention shown in FIG. 10, a valve 151 capable of opening and closing the ink supplying tube 103 is at the upstream side of the filter unit 104 in the adapter 102. When the filter unit 104 is changed, the valve 151 is closed, and leaking of the ink 100 from the ink supplying tube 103 can be prevented and air bubbles flowing into the ink supplying tube 103 can be prevented.

### Seventh Embodiment

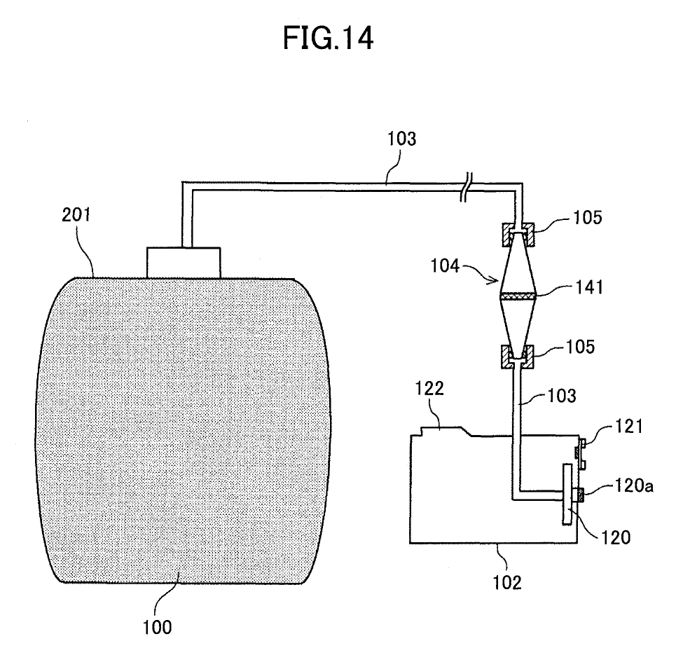

Next, referring to FIG. 14, an ink supplying system according to a seventh embodiment of the present invention is described. FIG. 14 is a schematic diagram showing the ink supplying system according to the seventh embodiment of the present invention.

In the seventh embodiment of the present invention, when an element is similar to or the same as that in the first embodiment of the present invention, the same reference number as that in the first embodiment of the present invention is used for the element, and the same description as that in the first embodiment of the present invention is omitted.

As shown in FIG. 14, when the ink supplying system according to the seventh embodiment of the present invention is compared with the ink supplying system according to the first embodiment of the present invention shown in FIG. 5, the ink tank 101 shown in FIG. 5 is replaced with an ink bag 201 having flexibility. With this, the ink tank 201 can be formed by a cost lower than the cost of the ink tank 101. In addition, when the filter unit 104 is changed, air bubbles can be discharged together with the ink 100 by the method using the syringe 200 described in the first embodiment of the present invention. Further, since the ink bag 201 is formed of a flexible material, when the ink bag 201 is pushed, the air bubbles in the ink bag 201 and the ink supplying tube 103 can be discharged together with the ink 100.

### Eighth Embodiment

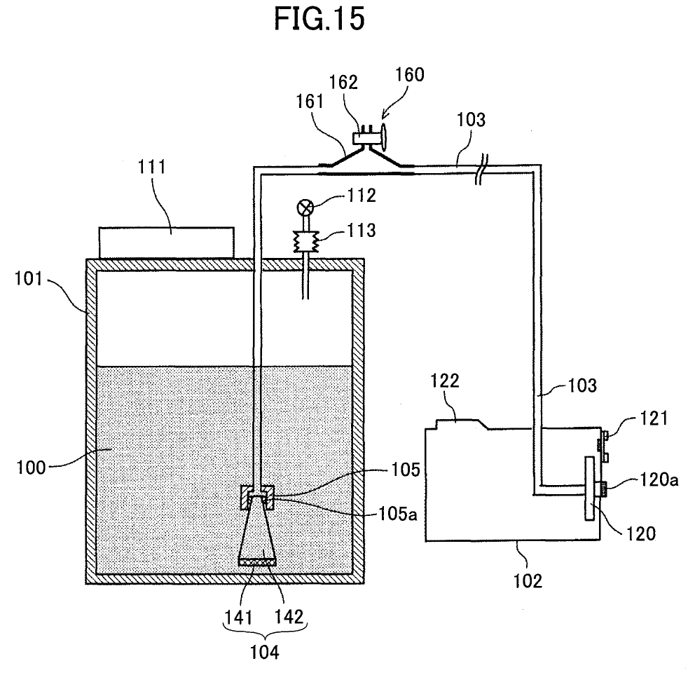

Next, referring to FIG. 15, an ink supplying system according to an eighth embodiment of the present invention is described. FIG. 15 is a schematic diagram showing the ink supplying system according to the eighth embodiment of the present invention.

In the eighth embodiment of the present invention, when an element is similar to or the same as that in the second embodiment of the present invention, the same reference number as that in the second embodiment of the present invention is used for the element, and the same description as that in the second embodiment of the present invention is omitted.

As shown in FIG. 15, when the ink supplying system according to the eighth embodiment of the present invention is compared with the ink supplying system according to the second embodiment of the present invention shown in FIG. 8, an air bubble discharging unit 160 is newly added to the second embodiment of the present invention shown in FIG. 8. The air bubble discharging unit 160 is in the middle of the ink supplying tube 103 between the ink tank 101 and the adapter 102. The air bubble discharging unit 160 includes an air bubble discharging route 161 and an air open valve 162 (second air open valve). When the filter unit 104 is changed, air bubbles flowing into the ink supplying tube 103 can be discharged by opening the air open valve 162.

Since the air bubble discharging unit 160 is at the downstream side of the filter unit 104, the air bubbles flowing into the ink supplying tube 103 can be discharged from the air bubble discharging unit 160.

### Ninth Embodiment

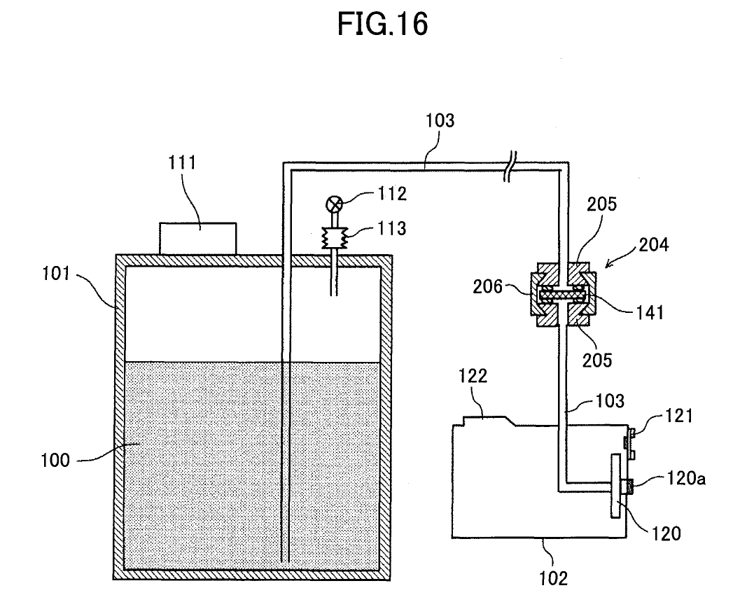

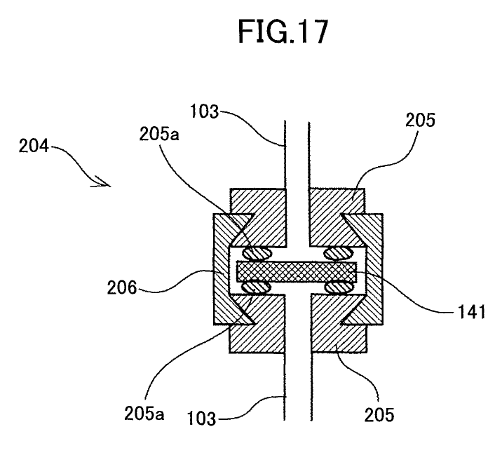

Next, referring to FIGS. 16 and 17, an ink supplying system according to a ninth embodiment of the present invention is described. FIG. 16 is a schematic diagram showing an ink supplying system according to the ninth embodiment of the present invention. FIG. 17 is an enlarged view of a filter unit shown in FIG. 16.

In the ninth embodiment of the present invention, when an element is similar to or the same as that in the first embodiment of the present invention, the same reference number as that in the first embodiment of the present invention is used for the element, and the same description as that in the first embodiment of the present invention is omitted.

As shown in FIGS. 16 and 17, when the ink supplying system according to the ninth embodiment of the present invention is compared with the ink supplying system according to the first embodiment of the present invention shown in FIGS. 5 and 6, in the ninth embodiment of the present invention, the filter unit 104 in the first embodiment of the present invention is replaced with a filter unit 204. The filter unit 204 includes the filter 141, joints 205, O-rings 205a, and a connecting member 206. In the filter unit 204, the filter 141 is sandwiched between the joints 205 connecting to the corresponding ink supplying tubes 103 via the O-rings 205a, and the connecting member 206 connects the joints 205. Protrusions of the connecting member 206 engage corresponding concave parts of the joints 205, and the joints 205 are firmly connected to the connecting member 206 by forces of the O-rings 205a.

When the filter 141 is desired to be changed, the connecting member 206 is removed from the joints 205. That is, only the filter 141 can be changed. Therefore, the cost can be reduced.

### Tenth Embodiment

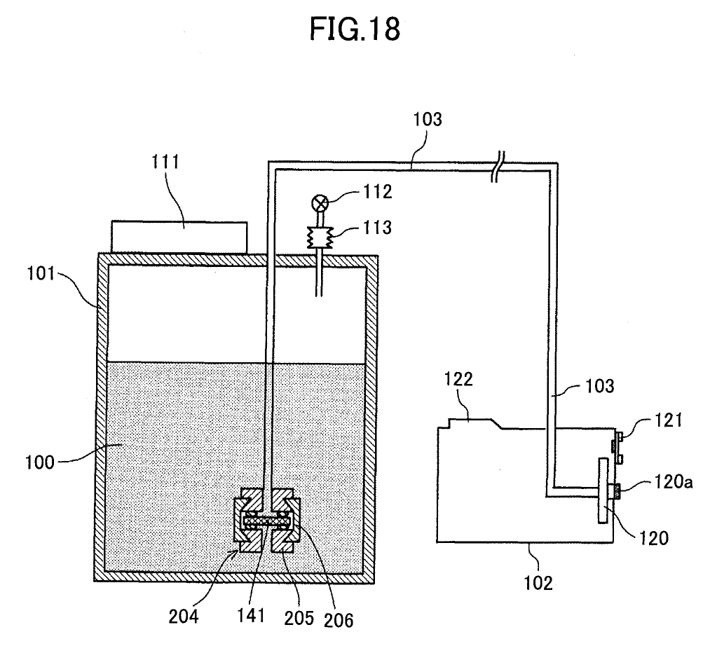

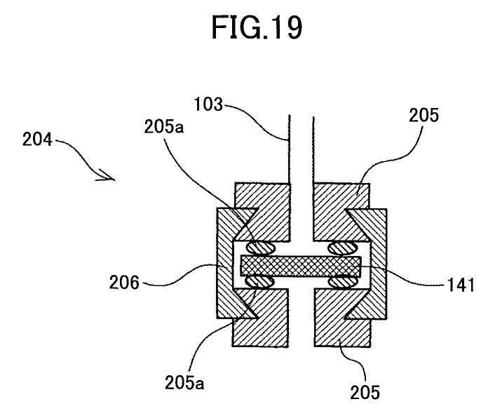

Next, referring to FIGS. 18 and 19, an ink supplying system according to a tenth embodiment of the present invention is described. FIG. 18 is a schematic diagram showing an ink supplying system according to the tenth embodiment of the present invention. FIG. 19 is an enlarged view of a filter unit shown in FIG. 18.

In the tenth embodiment of the present invention, when an element is similar to or the same as that in the ninth embodiment of the present invention, the same reference number as that in the ninth embodiment of the present invention is used for the element, and the same description as that in the ninth embodiment of the present invention is omitted.

As shown in FIGS. 18 and 19, when the ink supplying system according to the tenth embodiment of the present invention is compared with the ink supplying system according to the ninth embodiment of the present invention, in the tenth embodiment of the present invention, similar to the second embodiment of the present invention, one end of the filter unit 204 is connected to the ink supplying tube 103 in the ink tank 101 and the other end of the filter unit 204 is in direct connection with the ink 100 in the ink tank 101, and the size of the opening of the ink tank 101 is greater than the size in the ninth embodiment of the present invention so that the filter unit 204 can be easily extracted.

When the filter 141 is desired to be changed, the connecting member 206 is removed from the joints 205. That is, only the filter 141 can be changed.

In addition, air bubbles entering when the filter unit 204 is changed can be discharged by the same method as that in the first embodiment of the present invention.

Further, the present invention is not limited to the specifically disclosed embodiments, and variations and modifications may be made without departing from the scope of the present invention.

The present invention is based on Japanese Priority Patent Application No. 2007-194207, filed on Jul. 26, 2007, with the Japanese Patent Office, the entire contents of which are hereby incorporated herein by reference.

What is claimed is:

1. An ink supplying system, comprising:
an ink storing section which stores ink;
an adapter, which is detachably attached to an ink cartridge attaching section of a main body of an image forming apparatus to which ink cartridge attaching section an ink cartridge is originally detachably attached, and includes a connecting section with which the adapter is connected to the main body of the image forming apparatus;
an ink supplying tube which forms an ink supplying route for connecting the ink storing section to the connecting section of the adapter; and
a filter unit which filters out foreign substances in the ink at a position in the ink supplying route which route connects the ink storing section to the connecting section of the adapter; wherein
the filter unit is changeable.

2. The ink supplying system as claimed in claim 1, wherein:
the filter unit is at a position in the middle of the ink supplying route which route connects the ink storing section to the connecting section of the adapter.

3. The ink supplying system as claimed in claim 1, wherein:
the filter unit is at the end of the ink supplying tube in the ink storing section.

4. The ink supplying system as claimed in claim 1, wherein:
the filter unit is in the adapter.

5. The ink supplying system as claimed in claim 2, further comprising:
one or more valves in the ink supplying route which route connects the ink storing section to the connecting section of the adapter.

6. The ink supplying system as claimed in claim 3, further comprising:
a valve in front of the filter unit in the ink supplying route.

7. The ink supplying system as claimed in claim 4, further comprising:
a valve in front of the adapter in the ink supplying route.

8. The ink supplying system as claimed in claim 2, further comprising:
a first air open valve secured to the ink storing section; and
an air pump connected between the first air open valve and the ink storing section.

9. The ink supplying system as claimed in claim 3, further comprising:
a first air open valve secured to the ink storing section;
an air pump connected between the first air open valve and the ink storing section; and
a second air open valve in the ink supplying route which route connects the ink storing section to the connecting section of the adapter; wherein
the second air open valve is at a downstream side of the filter unit in the ink supplying route.

10. The ink supplying system as claimed in claim 4, further comprising:
a first air open valve secured to the ink storing section; and
an air pump connected between the first air open valve and the ink storing section.

11. The ink supplying system as claimed in claim 1, wherein:
the filter unit include a filter for filtering out the foreign substances in the ink; and
the filter is independently changeable.
